(19) United States
(12) Patent Application Publication
(10) Pub. No.: US 2020/0073997 A1
(43) Pub. Date: Mar. 5, 2020

(54) METHOD AND SYSTEM FOR ACCESSING DATA FROM A MANUAL

(71) Applicant: GM Global Technology Operations LLC, Detroit, MI (US)

(72) Inventors: Eli Tzirkel-Hancock, Ra'anana (IL); Oana Sidi, Ramat Hasharon (IL)

(73) Assignee: GM Global Technology Operations LLC, Detroit, MI (US)

(21) Appl. No.: 16/116,138

(22) Filed: Aug. 29, 2018

(51) Int. Cl. G06F 17/30; G10L 15/22; G06F 15/18

(52) U.S. Cl. CPC G06F 17/30643; G06F 17/30687; G10L 2015/223; G10L 15/22; G06F 15/18; G06F 17/30684

(57) ABSTRACT

A method of accessing data from an owner's manual saved in a memory of a computing device includes inputting a query into the computing device. A query classifier classifies the query into one of a plurality of categories. A text analyzer identifies at least one candidate section of the manual related to the query. A candidate classifier classifies each of the candidate sections into one of the plurality of categories, and assigns a confidence score to each respective candidate section. The computing device outputs the candidate sections, based on their respective confidence score, that are classified in the same category as the query as an answer to the query.

### INTRODUCTION

The disclosure generally relates to a method and system for accessing data from a manual.

An owner's manual includes data and/or information related to one or more specific products. For example, an owner's manual for a vehicle may include information related to the operation of the vehicle, maintenance of the vehicle, etc. A user may reference the owner's manual to obtain the information stored therein. Traditionally, the owner's manual has been provided in print form. The user would visually browse the printed owner's manual to obtain the information needed. Recently, owner's manuals are being provided in digital form, and are stored in a memory of a computing device. The computing device may include a computer incorporated into the vehicle, but may alternatively include a hand held device, such as but not limited to, a smart phone, tablet, etc. The computing device may be used to access the information stored in the electronic owner's manual.

### SUMMARY

A method of accessing data from a manual saved in a memory of a computing device is provided. The method includes inputting a query into the computing device. A query classifier operable on the computing device classifies the query into one of a plurality of categories. A text analyzer operable on the computing device identifies at least one candidate section of the manual related to the query. A candidate classifier operable on the computing device classifies each of the candidate sections into one of the plurality of categories. The computing device outputs at least one of the candidate sections that is classified in the same category as the query with a communicator, as an answer to the query.

In one aspect of the method of accessing data from the manual, the query is a verbal query that is input into the computing device. The computing device may use a voice-to-text algorithm to convert the verbal query to text, and save the text in an electronic data file.

In one aspect of the method of accessing data from the manual, the computing device may use the text analyzer to identify keywords in the query, and identifying a section of the manual including at least one of the keywords of the query as one of the candidate sections.

In one aspect of the method of accessing data from the manual, the computing device identifies the candidate sections related to the query after inputting the query into the computing device. In other words, the candidate sections are not pre-tagged prior to the search query.

In one aspect of the method of accessing data from the manual, the computing device may use the candidate classifier to assign a confidence score to each of the candidate sections. The confidence score is a measure of how much each respective candidate section relates to the category that it is classified in. The computing device may output the candidate sections based on the confidence score. For example, the computing device may output the candidate sections that are classified in the same category as the query in a sequential order based on the respective confidence score of each respective candidate section. The sequential order may include, for example, a descending order in which the candidate section having the highest confidence score is output first.

In one aspect of the method of accessing data from the manual, the query classifier and the candidate classifier may be continually re-defined using a computer learning algorithm to improve their effectiveness.

In another aspect of the method of accessing data from the manual, the computing device may use a matching model to identify one or more of the candidate sections that are classified in the same category as the query. The matching model may be continually re-defined using a computer learning algorithm to improve the effectiveness of the matching model.

A computing device for accessing data from a manual is also provided. The computing device includes a processor and a memory. The manual is saved in the memory. A data retrieval algorithm is also saved in the memory of the computing device. The processor is operable to execute the data retrieval algorithm to implement a method of accessing the data in the manual. As such, the processor is operable to execute the data retrieval algorithm to receive a query. The query is classified into one of a plurality of categories. At least one candidate section of the manual related to the query is then identified. Each of the candidate sections is classified into one of the plurality of categories. One of the candidate sections that is classified in the same category as the query is output as a response to the query.

In one aspect of the computing device, the query is a verbal query, and the processor is operable to execute the data retrieval algorithm to convert the verbal query to a text data file. The computing device may then identify at least one key word in the text data file, and identify a section of the manual including one of the at least one keywords of the text data file as one of the candidate sections.

In one aspect of the computing device, the processor is operable to execute the data retrieval algorithm to assign a confidence score to each of the candidate sections. The confidence score is a measure of how much each respective candidate section relates to the category that it is classified in. The computing device may output the candidate sections that are classified in the same category as the query in a sequential order based on the respective confidence score of each respective candidate section. The sequential order may include a descending order in which the candidate section having the highest confidence score is output first.

A vehicle is also provided. The vehicle includes an input device, an output device, and a computing device. The computing device is disposed in communication with the input device and the output device. The computing device includes a processor and a memory having a manual and a data retrieval algorithm saved thereon. The processor is operable to execute the data retrieval algorithm to implement a method of accessing data from the manual. The processor executes the data retrieval algorithm to receive a query of the manual through the input device. The computing device classifies the query into one of a plurality of categories, and identifies at least one candidate section of the manual related to the query. The computing device also classifies each of the at least one candidate section into one of the plurality of categories, and assigns a confidence score to each of the candidate sections. The confidence score is a measure of how much each respective candidate section relates to the category that it is classified in. The computing device then identifies the candidate sections that are classified in the same category as the query, and outputs the candidate sections that are classified in the same category as the query in a sequential order based on the respective confidence score of each respective candidate section. The sequential order may include a descending order in which the candidate section having the highest confidence score is output first.

In one aspect of the vehicle, the query is a verbal query, and the processor is operable to execute the data retrieval algorithm to convert the verbal query to a text data file. The computing device may then identify at least one key word in the text data file, and identify a section of the manual including one of the at least one keywords of the text data file as one of the candidate sections.

The method of accessing data from the manual described herein is a new process that provides better results than prior data retrieval processes, in which the manual had to be manually tagged with pre-defined search words/phrases/categories. The process described herein eliminates the need to manually tag the sections of the manual prior to entering the search query, and provides more accurate results.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic view of a vehicle.

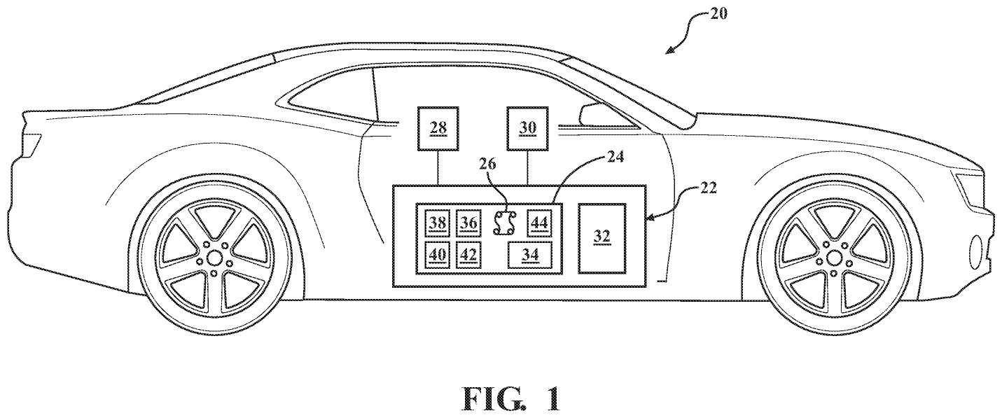

FIG. 2 is a flowchart representing a method of accessing data from a manual.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of a number of hardware, software, and/or firmware components configured to perform the specified functions.

Referring to the FIGS., wherein like numerals indicate like parts throughout the several views, a vehicle is generally shown at 20. The vehicle 20 may include a moveable platform, such as but not limited to a car, a truck, a plane, a boat, etc. The specific type and configuration of the vehicle 20 is not pertinent to the teachings of this disclosure, and is therefore not described in detail herein.

The vehicle 20 includes a computing device 22. The computing device 22 includes a memory 24 having a manual 26, e.g., an owner's or operator's manual, stored thereon. The computing device 22 is operable to access data from the manual 26. While the detailed description describes an exemplary embodiment in which the computing device 22 is incorporated into the vehicle 20, it should be appreciated that the computing device 22 may be separate from the vehicle 20, and that teachings of the disclosure may be practiced without the vehicle 20. As such, the exemplary embodiment described herein in which the vehicle 20 includes the computing device 22 to access data from an operator's manual 26 is exemplary. Other embodiments may include the computing device 22 embodied as a handheld device, such as but not limited to, a smartphone, a tablet, etc. Other embodiments may include the computing device 22 embodied as a desktop or laptop computer.

The computing device 22 includes and is disposed in communication with an input device 28 and an output device 30. The input device 28 may include a device that is capable of inputting a command into the computing device 22. For example, the input device 28 may include, but is not limited to, a microphone, a keyboard, a touch screen, etc. The output device 30 may alternatively be referred to as a communicator, and may include a device that is capable of communicating a message from the computing device 22 to a user. For example, the output device 30 may include, but is not limited to, a speaker, a display screen, etc.

In addition to the memory 24, the computing device 22 includes a processor 32. The manual 26 is stored in the memory 24 as a data file. The computing device 22 further includes a data retrieval algorithm 34 saved in the memory 24. The processor 32 is operable to execute the data retrieval algorithm 34 to implement a method of accessing data from the manual 26 saved in the memory 24 of the computing device 22.

The computing device 22 may alternatively be referred to as a computer, a controller, a module, a control module, a control unit, etc., The computing device 22 includes the memory 24 and the processor 32, and includes software, hardware, memory, algorithms, connections, sensors, etc., for managing and controlling data access to the manual 26. As such, the method of accessing data from the manual 26 may be embodied as a program or algorithm operable on the computing device 22. It should be appreciated that the computing device 22 may include a device capable of analyzing data from various sensors and/or the input device 28, comparing data, making the decisions required to access the data in the manual 26, and execute the required tasks for outputting the data from the manual 26 via the output device 30.

The computing device 22 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and required input/output (I/O) circuitry, I/O devices, and communication interfaces, as well as signal conditioning and buffer electronics.

In the exemplary embodiment shown in the Figures and described herein, the computing device 22 of the vehicle 20 includes the memory 24 and the processor 32. The memory 24 includes, but is not limited to, a query classifier 36, a candidate classifier 38, a matching model 40, a text analyzer 42, and a voice-to-text algorithm 44, described in greater detail below. However, in other embodiments one or more of these components may be located at a remote location, such as but not limited to on a remote internet server, i.e., a cloud server. For example, in one alternative embodiment, both the memory 24 and the processor 32 may be located on a remote internet server, in which case the computing device 22 would include an algorithm or software that communicates with the remote server, the input device 28, and the output device 30. In another embodiment, the voice-to-text algorithm 44 may be located on a remote internet server, i.e., a cloud server, in which case the computing device 22 would include an algorithm or software that communicates what the voice-to-text algorithm 44 on the remote server. Those skilled in the art should appreciated that many different combinations of software/hardware locations and/or communication paths are possible to enable the method described below.

The computer-readable memory 24 may include any non-transitory/tangible medium which participates in providing data or computer-readable instructions. The memory 24 may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or other optical medium, as well as other possible memory devices such as flash memory.

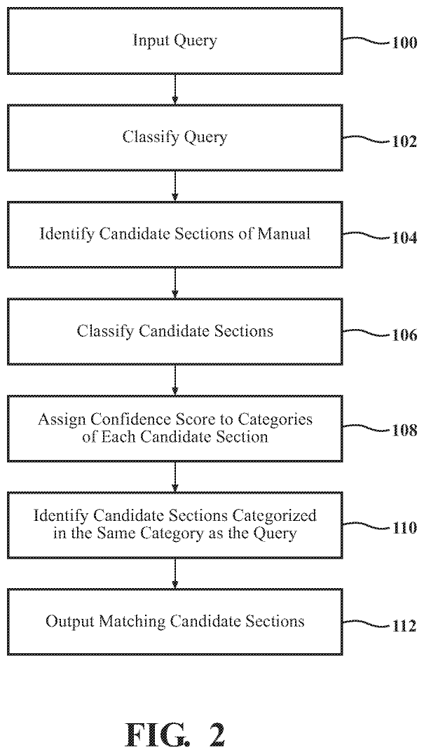

As noted above, the processor 32 is operable to execute the data retrieval algorithm 34 to implement the method of accessing data from the manual 26 saved in the memory 24 of the computing device 22. The method includes inputting a query into the computing device 22. The step of inputting the query into the computing device 22 is generally indicated by box 100 in FIG. 2. The query may be considered a request to access data from the manual 26. In an exemplary embodiment, the query may be in the form of a question input into the computing device 22 for information regarding a specific topic. The query may be input into the computing device 22 in a suitable manner. For example, the query may be input into the computing device 22 in the form of text using a keyboard or touch screen display. The textual input may be saved as a text data file in the memory 24 of the computing device 22. In other embodiments, the query may include a verbal query, and may be input into the computing device 22 using a microphone. If the query is made verbally, the computing device 22 may include a voice-to-text algorithm 44 that is capable of converting verbal inputs into a textual input. The computing device 22 may convert the verbal inquiry into to a text data file, and then save the text data file in the memory 24 of the computing device 22.

The computing device 22 classifies the query into one of a plurality of categories with a query classifier 36. The step of classifying the query is generally indicated by box 102 in FIG. 2. The query classifier 36 is a classifying algorithm that is operable on the computing device 22. The query classifier 36 examines the query, and determines which one of the plurality of different categories the query is most closely associated with. Exemplary embodiments of the different categories may include, but are not limited to, an overview description category, a warning category, a caution category, a location category, an instruction category, a reference category, a recommendation category, or a troubleshooting category. For example, if the query is a question asking “How do I adjust head restraints?”, then the query classifier 36 may examine the context of the query and determine that the query is most closely associated with a request for an instruction regarding adjusting head restrains, and would classify the query in the “instruction” category. In another embodiment, if the query is a question asking “Where is the spare tire located?”, then the query classifier 36 may examine the context of the query and determine that the query is most closely associated with a request for a location of an object, and would classify the query in the “location” category. The query classifier 36 eliminates the need to ask the user to input or otherwise specify the type of information they are searching for.

The computing device 22 may then identify at least one candidate section of the manual 26 related to the query. The step of identifying candidate sections of the manual 26 is generally indicated by box 104 in FIG. 2. The computing device 22 may identify the candidate sections using a text analyzer algorithm 42 operable on the computing device 22. For example, the computing device 22 may use the text analyzer algorithm 42 to identify keywords in the query, such as by examining the text data file of the query. The text analyzer algorithm 42 then compares those keywords to the text of the manual 26 to locate one or more sections of the manual 26 that include at least one of the keywords identified in the query, or are otherwise related to the query. In other embodiments, the text analyzer algorithm 42 may use embedded word representations as the key words. As understood by those skilled in the art, an embedded word representation is numerical vector that encapsulate a semantic meaning of one or more similar words. For example, the embedded word representation for “car”, “vehicle”, or “automobile”, may all be the same or similar vector representations. Notably, the computing device 22 identifies the candidate sections related to the query after the query has been input into the computing device 22. Accordingly, the different sections of the manual 26 are not “pre-tagged” with a list of keywords. Rather, the computing device 22 first develops the keywords from the query, and then searches the text of the manual 26 to locate sections that include one or more of the keywords identified in the query. By operating in this manner, the process described herein is not limited to pre-defined tags associated with the manual 26. The process described herein eliminates the need to pre-tag the different sections of the manual 26 with possible search terms. This enables a broader variety of search terms to access the data in the manual 26, and improves data retrieval.

For example, in the exemplary query noted above, requesting “How do I adjust the head restraints?”, the computing device 22 may identify the keywords “adjust” and “head restraint”, and then search the manual 26 for these terms. In response to the search, the computing device 22 may identify one or more sections or paragraphs of the manual 26 that include one or more of the keywords. For example, the computing device 22 may identify three different sections, i.e., a first section, a second section, and a third section. The first section may state “If equipped with base seats, the vehicle's 20 front seats have adjustable head restraints in the outboard seating positions.” The second section may state “Do not drive until the head restraints for occupants are installed and adjusted properly.” The third section may state “To raise or lower the head restraint, press the button located on the side of the head restraint, and pull up or push the head restrain down and release the button. Pull and push on the head restrain after the button is released to make sure that it is locked in place.”

The computing device 22 then uses a candidate classifier 38 to classify each of the identified candidate sections into at least one of the categories. The step of classifying the candidate sections into categories is generally indicated by box 106 in FIG. 2. The candidate classifier 38 may classify each of the candidate sections into multiple categories if appropriate. The candidate classifier 38 is a classifying algorithm that is operable on the computing device 22. The candidate classifier 38 examines each of the candidate sections individually, and determines which of the plurality of different categories the respective candidate section is associated with. The different categories for the candidate sections are the same as the categories for the queries. For example, the computing device 22 may examine the first section, which states “If equipped with base seats, the vehicle's 20 front seats have adjustable head restraints in the outboard seating positions”, and classify the first section in both the “overview” category and the “location” category, because the first section gives a broad overview of head restraints, and provides a location for the head restraints. The computing device 22 may examine the second section, which states “Do not drive until the head restraints for occupants are installed and adjusted properly”, and classify the second section in the “warning” category because it provides a warning regarding the operation of the vehicle 20. The computing device 22 may examine the third section, which states “To raise or lower the head restraint, press the button located on the side of the head restraint, and pull up or push the head restraint down and release the button. Pull and push on the head restraint after the button is released to make sure that it is locked in place”, and classify it in the “instruction” category because it provides instructions on how to adjust the head restraint. The computing device 22 may further classify the third section in the “location” category, because the third section provides a location for the release button to adjust the head restraint. Additionally, the computing device 22 may classify the third section in the “overview” category because the third section provides an overview of the operation of the head restraint. The candidate classifier 38 eliminates the need to pre-tag all of the different sections/paragraphs of the manual 26 with the semantic type of information that each section/paragraph contains.

In addition to classifying each of the respective candidate sections in a one or more respective categories, the candidate classifier 38 may further assign a confidence score to each category that each respective candidate section is classified in. The step of assigning confidence scores is generally indicated by box 108 in FIG. 2. The confidence score is a measure of how much each respective candidate section relates to the category that it is classified in. The confidence score may be defined in a suitable manner, such as by a number scale. For example, the confidence score may be defined by a number between 0 and 1.0, in which a confidence score of 0 indicates a very poor match, and a confidence score of 1.0 indicates a very good match. It should be appreciated that the confidence score may be represented in some other manner, such as with a different number scale, a letter scale, a percentage, etc.

Using the exemplary embodiment described above, the computing device 22 may assign a confidence score for the first section in both the “overview” category and the “location” category. For example, the computing device 22 may assign a confidence score for the first section in the “overview” category of 0.9, and assign a confidence score for the first section in the “location” category of 0.8. The computing device 22 may assign a confidence score for the second section in the “warning” category. For example, the computing device 22 may assign a confidence score for the second section in the “warning” category of 1.0. The computing device 22 may assign a confidence score for the third section in the “instruction” category, the “location” category, and the “overview” category. For example, the computing device 22 may assign a confidence score for the third section in the “instruction” category of 1.0, assign a confidence score for the third section in the “location” category of 0.9, and assign a confidence score for the third section in the “overview” category of 0.7.

The computing device 22 may then identify the candidate sections that are classified in the same category as the query with a matching model 40. The step of identifying the candidate sections that are classified into the same category as the query is generally indicated by box 110 in FIG. 2. The matching model 40 is a matching algorithm that is operable on the computing device 22. A candidate section that is classified in the same category as the query may be considered and hereinafter referred to as a matched candidate section. If more than one candidate section is classified in the same category as the query, then the matching model 40 may prioritize the candidate sections based on their respective confidence score.

Once the computing device 22 has identified the candidate sections that are classified in the same category as the query, the computing device 22 outputs one or more of the matching candidate sections as an answer to the query, with the output device 30. The step of outputting the matched candidate sections is generally indicated by box 112 in FIG. 2. The specific manner in which the selected candidate section is output depends upon the type of output device 30. For example, if the output device 30 is a display screen, then the selected candidate section may be output as text displayed on the display screen. In another embodiment, if the output device 30 is a speaker, then the selected candidate section may be output verbally through the speaker. If multiple candidate sections are classified in the same category as the query, then the computing device 22 may output each of the matched candidate sections as an answer to the query. However, as noted above, the matched candidate sections may be output based on their respective confidence score. A higher confidence score indicates that that particular candidate section is more closely related to the query than a lower confidence score. Accordingly, a matched candidate section having a higher confidence score may be more likely to be responsive to the query than a matched candidate section with a lower confidence score. Therefore, the matched candidate sections may be output in a sequential order based on the respective confidence score of each respective candidate section, with the sequential order being a descending order in which the candidate section having the highest confidence score is output first.

In the example described herein, the query was classified in the “instruction” category, and the third section was similarly classified in the “instruction” category. Accordingly, in response to the query “How do I adjust the head restraints?”, the computing device 22 would output the third section, which states that “To raise or lower the head restraint, press the button located on the side of the head restraint, and pull up or push the head restraint down and release the button. Pull and push on the head restraint after the button is released to make sure that it is locked in place.” The computing device 22 would not automatically output the first section and/or the second section, because those candidate sections were not classified into the “instruction” category.

The query classifier 36, the candidate classifier 38 and the matching model 40 may be defined in a suitable manner. For example, each of the query classifier 36, the candidate classifier 38, and the matching model 40 may be defined initially through programming, and then redefined after use using a computing learning algorithm, model building, or crowd sourcing techniques understood by those skilled in the art to improve the efficiency of each. The revised algorithms, i.e., the query classifier 36, the candidate classifier 38, and the matching model 40 may then be updated on the computing device 22 to provide improved performance.

The process described herein for accessing data from the manual 26 eliminates the need to pre-tag the manual 26 with search terms, and provides an automatic process that may be applied across several different manuals. Pre-tagging manuals requires that each section of the manual be defined by a programmer with one or more search terms. Each different manual is be pre-tagged. This is labor intensive and limits search precision. The process described herein does not require that the manual 26 be pre-tagged, improves the search precision compared to searching for pre-tagged sections, and reduces development costs for the manual.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A method of accessing data from a manual saved in a memory of a computing device, the method comprising:
inputting a query into the computing device;
classifying the query into one of a plurality of categories with a query classifier operable on the computing device;
identifying at least one candidate section of the manual related to the query with a text analyzer operable on the computing device;
classifying each of the candidate sections into one of the plurality of categories with a candidate classifier operable on the computing device; and
outputting at least one of the candidate sections that is classified in the same category as the query with a communicator of the computing device.

2. The method set forth in claim 1, wherein inputting the query into the computing device includes inputting a verbal query into the computing device.

3. The method set forth in claim 2, wherein inputting the verbal query into the computing device includes converting the verbal query to text with a voice-to-text algorithm operable on the computing device.

4. The method set forth in claim 1, wherein identifying the at least one candidate section related to the query is further defined as identifying the at least one candidate section related to the query after inputting the query into the computing device.

5. The method set forth in claim 1, wherein identifying the at least one candidate section related to the query includes identifying keywords in the query, and identifying any section of the manual including at least one of the keywords of the query as one of the at least one candidate sections, with the text analyzer.

6. The method set forth in claim 1, further comprising assigning a confidence score to each of the candidate sections, with the candidate classifier, wherein the confidence score is a measure of how much each respective candidate section relates to the category that it is classified in.

7. The method set forth in claim 6, wherein outputting the at least one of the candidate sections that is classified in the same category as the query includes outputting the candidate sections that are classified in the same category as the query in a sequential order based on the respective confidence score of each respective candidate section, wherein the sequential order is a descending order in which the candidate section having the highest confidence score is output first.

8. The method set forth in claim 1, further comprising defining the query classifier using a computer learning algorithm.

9. The method set forth in claim 1, further comprising defining the candidate classifier using a computer learning algorithm.

10. The method set forth in claim 1, further comprising identifying any of the candidate sections that are classified in the same category as the query with a matching model operable on the computing device.

11. The method set forth in claim 10, further comprising defining the matching model using a computer learning algorithm.

12. A computing device for accessing data from a manual, the system comprising:
a processor;
a memory having the manual and a data retrieval algorithm saved thereon, wherein the processor is operable to execute the data retrieval algorithm to:
receive a query;
classify the query into one of a plurality of categories;
identify at least one candidate section of the manual related to the query;
classify each of the at least one candidate section into one of the plurality of categories; and
output one of the at least one candidate section that is classified in the same category as the query as a response to the query.

13. The computing device set forth in claim 12, wherein the query is a verbal query, and wherein the processor is operable to execute the data retrieval algorithm to convert the verbal query to a text data file.

14. The computing device set forth in claim 13, wherein the processor is operable to execute the data retrieval algorithm to identify at least one key word in the text data file, and identify a section of the manual including one of the at least one keywords of the text data file.

15. The computing device set forth in claim 12, wherein the processor is operable to execute the data retrieval algorithm to assign a confidence score to each of the candidate sections, wherein the confidence score is a measure of how much each respective candidate section relates to the category that it is classified in.

16. The computing device set forth in claim 15, wherein the processor is operable to execute the data retrieval algorithm to output the candidate sections that are classified in the same category as the query in a sequential order based on the respective confidence score of each respective candidate section, wherein the sequential order is a descending order in which the candidate section having the highest confidence score is output first.

17. A vehicle comprising:
an input device;
an output device; and
a computing device in communication with the input device and the output device, and including a processor and a memory having a manual and a data retrieval algorithm saved thereon, wherein the processor is operable to execute the data retrieval algorithm to:
receive a query of the manual through the input device;
classify the query into one of a plurality of categories;
identify at least one candidate section of the manual related to the query;
classify each of the at least one candidate section into one of the plurality of categories;
assign a confidence score to each of the candidate sections, wherein the confidence score is a measure of how much each respective candidate section relates to the category that it is classified in;
identifying any of the candidate sections that are classified in the same category as the query; and
output the candidate sections that are classified in the same category as the query in a sequential order based on the respective confidence score of each respective candidate section, wherein the sequential order is a descending order in which the candidate section having the highest confidence score is output first.

18. The vehicle set forth in claim 17, wherein the query is a verbal query, and wherein the processor is operable to execute the data retrieval algorithm to convert the verbal query to a text data file.

19. The vehicle set forth in claim 18, wherein the processor is operable to execute the data retrieval algorithm to identify at least one key word in the text data file, and identify a section of the manual including one of the at least one keywords of the text data file.
